(19) United States
(12) Patent Application Publication
(10) Pub. No.: US 2025/0047413 A1
(43) Pub. Date: Feb. 6, 2025

(54) SYSTEM AND METHOD FOR CONTROL FRAME PROTECTION

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Ken Kinwah Ho, San Jose, CA (US)

(21) Appl. No.: 18/794,803

(22) Filed: Aug. 5, 2024

Related U.S. Application Data
(60) Provisional application No. 63/517,670, filed on Aug. 4, 2023.
(60) Provisional application No. 63/581,790, filed on Sep. 11, 2023.
(60) Provisional application No. 63/561,341, filed on Mar. 5, 2024.

(51) Int. Cl. H04L 1/00; H04L 1/1607

(52) U.S. Cl. CPC H04L 1/0072; H04L 1/0057; H04L 1/0083; H04L 1/1642

(57) ABSTRACT

Embodiments of a method and apparatus for communications are disclosed. In an embodiment, a communications device includes a controller configured to generate a control frame carrying security related information for frame integrity protection in different locations in the control frame with other information in between the security related information and a wireless transceiver configured to wirelessly transmit the control frame to a second communications device.

### CROSS-REFERENCE TO RELATED APPLICATIONS

This application is entitled to the benefit of U.S. Provisional Patent Application Ser. No. 63/517,670, filed on Aug. 4, 2023, U.S. Provisional Patent Application Ser. No. 63/581,790, filed on Sep. 11, 2023, and U.S. Provisional Patent Application Ser. No. 63/561,341, filed on Mar. 5, 2024, the contents of which are incorporated by reference herein.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey communications signaling information, for example, information related to data, communications links, and/or multi-link devices (e.g., operation and/or capability parameters of multi-link devices) within a multi-link communications system.

### SUMMARY

Embodiments of a method and apparatus for communications are disclosed. In an embodiment, a communications device includes a controller configured to generate a control frame carrying security related information for frame integrity protection in different locations in the control frame with other information in between the security related information and a wireless transceiver configured to wirelessly transmit the control frame to a second communications device. Other embodiments are also disclosed.

In an embodiment, the security related information includes frame protection indication information regarding whether or not the control frame is a protected control frame, key identification (ID) information, packet number (PN) information, and message integrity check (MIC) information.

In an embodiment, the frame protection indication information and the key ID information are separated from the PN information and the MIC information.

In an embodiment, the PN information and the MIC information are located right after block acknowledgement request (BAR) Information in a protected BAR frame, right after block acknowledgement (BA) Information in a protected BA frame, or right after a User Info List in a protected trigger frame.

In an embodiment, the frame protection indication information, the key ID information, and the PN information are separated from the MIC information.

In an embodiment, if additional processing time is required, the control frame further includes a padding field that is located after the MIC information if the control frame is a protected block acknowledgement request (BAR) frame or a protected block acknowledgement (BA) frame.

In an embodiment, the control frame further includes a pre-padding frame check sequence (FCS) field that is located after the MIC information.

In an embodiment, the communications device or the second communications device includes a wireless access point (AP), and the second communications device or the communications device includes a wireless non-AP station (STA).

In an embodiment, the control frame includes a protected control frame, frame protection indication information is repurposed by using a current reserved bit of the protected control frame.

In an embodiment, the control frame includes a protected trigger frame, a protected block acknowledgement (BA) frame, or a protected block acknowledgement request (BAR) frame.

In an embodiment, the control frame includes the protected trigger frame, and frame protection indication information or key identification (ID) information is repurposed by using at least one current reserved bit of a special user information field or a common information field of the protected trigger frame.

In an embodiment, the PN information and the MIC information are carried in a Security User Info field with an Association ID (AID) 12 field carrying a special value where the Security User Info field has the same length as a Special User Info field, a Trigger Dependent User Info field in each Security User Info field is reserved, only the User Info subfield in a last Security User Info field has reserved bits if not all User Info subfields are used.

In an embodiment, a Pre-padding frame check sequence (FCS) is carried in a Pre-padding FCS Info field with an AID12 field carrying a special value where the Pre-padding FCS Info field has the same length as the Special User Info field, a Trigger Dependent User Info field in each Pre-padding FCS Info field is reserved, only the User Info subfield in last Pre-padding FCS Info field has reserved bits if not all FCS Info subfields are used.

In an embodiment, the PN information and the MIC information are carried after 16-bit all Is in a Padding field.

In an embodiment, a pre-padding frame check sequence (FCS) is carried after the PN information and the MIC information.

In an embodiment, the control frame includes the protected BA frame, frame protection indication information or key identification (ID) information is repurposed by using at least one current reserved bit of a BA control field of the protected BA frame, and the protected BA frame includes a protected multi-station (STA) BA frame where the PN information and the MIC information are carried in a Security Per AID TID Info field with a special value in an AID11 subfield, a value of 0 in an acknowledgement (Ack) Type subfield, and a value in a Fragment Number subfield to indicate a length of a Security Info field.

In an embodiment, one or more Padding Per AID Traffic Identifier (TID) Info fields are carried after the Security Per AID TID Info field where padding if required by a recipient is carried in the Padding Per AID TID Info fields with a special value in an AID11 subfield, a value of 0 or 1 in an Ack Type subfield, and a value in a Fragment Number subfield to indicate a length of a Padding Info field.

In an embodiment, the control frame includes the protected BAR frame, frame protection indication information or key identification (ID) information is repurposed by using at least one reserved bit of a BAR control field of the protected BAR frame, and the protected BAR frame includes a protected compressed BAR framer or a protected compressed multi-TID BAR frame where the PN information and the MIC information are located after BAR information and padding required by a recipient is carried after the MIC information.

In an embodiment, a wireless access point (AP) compatible with an Institute of Electrical and Electronics Engineers (IEEE) 802.11 protocol includes a controller configured to generate a control frame carrying security related information for frame integrity protection in different locations in the control frame with other information in between the security related information and a wireless transceiver configured to wirelessly transmit the control frame to a second communications device.

In an embodiment, a method for wireless communications include at a first communications device, generating a control frame carrying security related information for frame integrity protection in different locations in the control frame with other information in between the security related information and from the first communications device, wirelessly transmitting the control frame to a second communications device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 illustrates a frame control field format of a protected control frame in accordance with an embodiment of the invention.

FIG. 5 illustrates a BAR frame format in accordance with an embodiment of the invention.

FIG. 6 illustrates a BAR control field format in accordance with an embodiment of the invention.

FIG. 7 illustrates a BA frame format in accordance with an embodiment of the invention.

FIG. 8 illustrates a BA control field format in accordance with an embodiment of the invention.

FIG. 9 illustrates a trigger frame format in accordance with an embodiment of the invention.

FIG. 10 illustrates a Special User Information (Info) field format in accordance with an embodiment of the invention.

FIG. 11 illustrates a frame control field format of a protected control frame in accordance with an embodiment of the invention.

FIG. 12 illustrates a BAR frame format in accordance with an embodiment of the invention.

FIG. 13 illustrates a BAR control field format in accordance with an embodiment of the invention.

FIG. 14 illustrates a BA frame format in accordance with an embodiment of the invention.

FIG. 15 illustrates a BA control field format in accordance with an embodiment of the invention.

FIG. 16 illustrates a trigger frame format in accordance with an embodiment of the invention.

FIG. 17 illustrates a Special User Info field format in accordance with an embodiment of the invention.

FIG. 18 illustrates a BAR frame format in accordance with an embodiment of the invention.

FIG. 19 illustrates a BAR control field format in accordance with an embodiment of the invention.

FIG. 20 illustrates a trigger frame format in accordance with an embodiment of the invention.

FIG. 21 illustrates a Security User Info field in accordance with an embodiment of the invention.

FIG. 22 illustrates a Pre-padding frame check sequence (FCS) User Info field in accordance with an embodiment of the invention.

FIG. 23 illustrates a trigger frame format in accordance with an embodiment of the invention.

FIG. 24 illustrates a Security User Info field in accordance with an embodiment of the invention.

FIG. 25 illustrates a trigger frame format in accordance with an embodiment of the invention.

FIG. 26 illustrates a BA frame format in accordance with an embodiment of the invention

FIG. 27 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

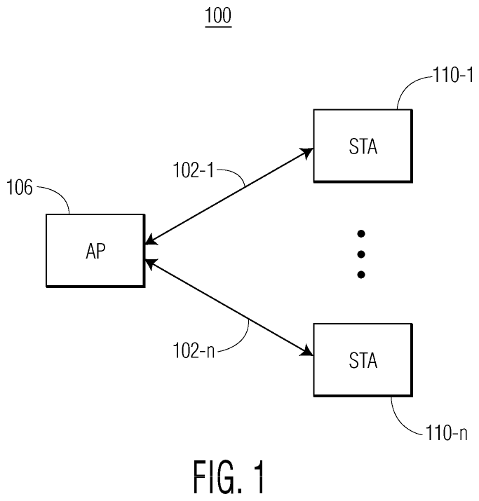

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

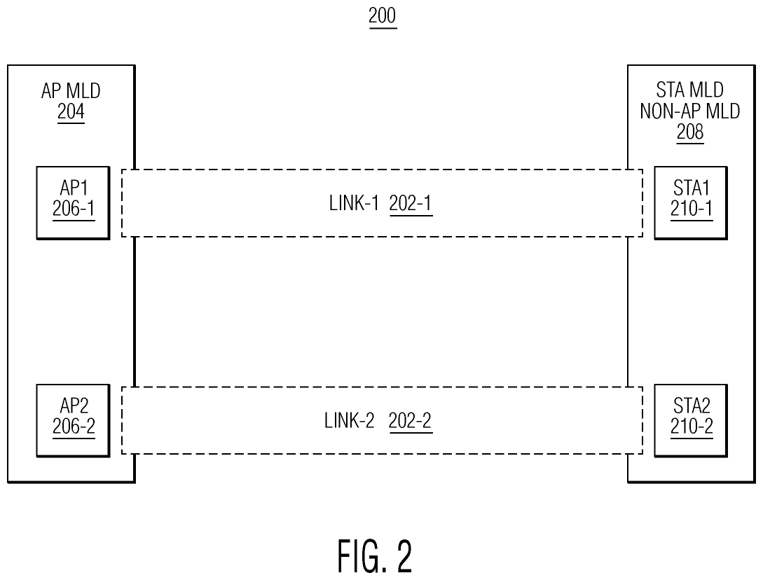

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

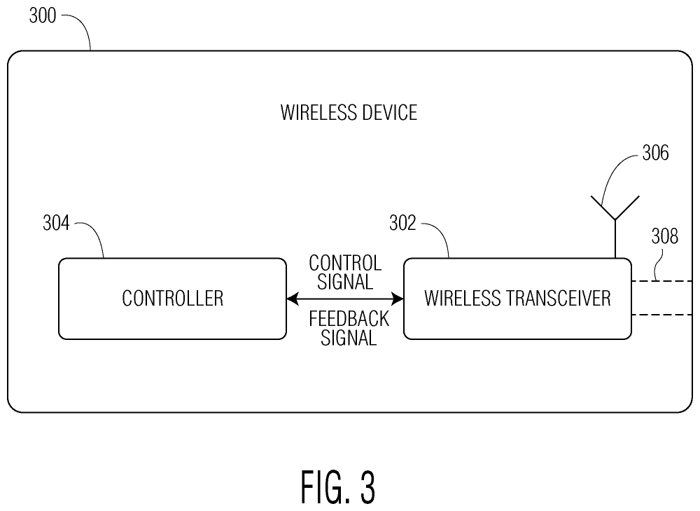

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 304 is configured to generate a control frame carrying security related information for frame integrity protection in different locations in the control frame with other information in between the security related information, and the wireless transceiver 302 is configured to wirelessly transmit the control frame to a second communications device. In some embodiments, the security related information includes frame protection indication information regarding whether or not the control frame is a protected control frame, key identification (ID) information, packet number (PN) information, and message integrity check (MIC) information. In some embodiments, the frame protection indication information and the key ID information are separated from the PN information and the MIC information. In some embodiments, the PN information and the MIC information are located right after block acknowledgement request (BAR) Information in a protected BAR frame, right after block acknowledgement (BA) Information in a protected BA frame, or right after a User Info List in a protected trigger frame. In some embodiments, the frame protection indication information, the key ID information, and the PN information are separated from the MIC information by other fields. In some embodiments, if additional processing time is required, the control frame further includes a padding field that is located after the MIC information if the control frame is a protected BAR frame or a protected BA frame. In some embodiments, the control frame further includes a pre-padding frame check sequence (FCS) field that is located after the MIC information. In some embodiments, the communications device or the second communications device includes a wireless access point (AP), and the second communications device or the communications device includes a wireless non-AP station (STA). In some embodiments, the control frame further includes a padding field that is located after the PN information. In some embodiments, the wireless device 300 includes a wireless access point (AP), and the second communications device includes a wireless non-AP station (STA). In some embodiments, the control frame includes a protected control frame (e.g., a protected multi-STA BA frame), and frame protection indication information is carried in a current reserved bit (e.g., the current reserved bit in the BA Control field) of the control frame (e.g., a multi-STA BA frame). In some embodiments, the control frame includes a protected control frame, and frame protection indication information is repurposed by using a current reserved bit of the protected control frame. In some embodiments, the control frame includes a protected trigger frame, a protected block acknowledgement (BA) frame, or a protected block acknowledgement request (BAR) frame. In some embodiments, the control frame includes the protected trigger frame, frame protection indication information or key identification (ID) information is carried in at least current one reserved bit of a special user information field or a common information field of the protected trigger frame by repurposing the current reserved bit to carry the Key ID. In some embodiments, the control frame includes the protected trigger frame, and frame protection indication information or key ID information is repurposed by using at least one current reserved bit of a special user information field or a common information field of the protected trigger frame. In some embodiments, the PN information and the MIC information are carried in a Security User Info field with an AID12 field carrying a special value where the Security User Info field has the same length as a Special User Info field, a Trigger Dependent User Info field in each Security User Info field is reserved, only the User Info subfield in a last Security User Info field has reserved bits if not all User Info subfields are used. In some embodiments, a Pre-padding FCS is carried in a Pre-padding FCS Info field with an AID12 field carrying a special value where the Pre-padding FCS Info field has the same length as the Special User Info field, a Trigger Dependent User Info field in each Pre-padding FCS Info field is reserved, only the User Info subfield in last Pre-padding FCS Info field has reserved bits if not all FCS Info subfields are used. In some embodiments, the PN information and the MIC information are carried after 16-bit all Is in a Padding field. In some embodiments, a pre-padding FCS is carried after the PN information and the MIC information. In some embodiments, the pre-padding FCS is not carried in a Trigger frame when MIC is carried in the Trigger frame and all addressed STAs of the Trigger frame need to check the FCS. In some embodiments, the control frame includes the protected BA frame, frame protection indication information or key identification (ID) information is carried in at least one current reserved bit of a BA control field of the protected BA frame by repurposing the current reserved bit to carry the Key ID. In some embodiments, the protected BA frame only includes the protected Multi-STA BA frame. In some embodiments, when the soliciting BAR or A-MPDU solicits a compressed BA frame or a multi-TID BA frame between two peer devices supporting control frame protection, the protected multi-STA BA is transmitted instead of a compressed BA frame or a multi-TID BA frame. In some embodiments, the control frame includes the protected BA frame, and frame protection indication information or key identification (ID) information is repurposed by using at least one current reserved bit of a BA control field of the protected BA frame, the protected BA frame includes a protected multi-station (STA) BA frame where the PN information and the MIC information are carried in a Security Per AID TID Info field with a special value in an AID11 subfield, a value of 0 in an acknowledgement (Ack) Type subfield, and a value in a Fragment Number subfield to indicate a length of a Security Info field. In some embodiments, one or more Padding Per AID TID Info fields are carried after the Security Per AID TID Info field where padding if required by a recipient is carried in the Padding Per AID TID Info fields with a special value in an AID11 subfield, a value of 0 or 1 in an Ack Type subfield, and a value in a Fragment Number subfield to indicate a length of a Padding Info field. In some embodiments, the control frame includes the protected BAR frame, frame protection indication information or key identification (ID) information is carried in at least one reserved bit of a BAR control field of the protected BAR frame. In some embodiments, the protected BAR frame only includes the protected compressed BAR frame and multi-TID BAR frame. In some embodiments, the control frame includes the protected BAR frame, frame protection indication information or key identification (ID) information is repurposed by using at least one reserved bit of a BAR control field of the protected BAR frame, and the protected BAR frame includes a protected compressed BAR framer or a protected compressed multi-TID BAR frame where the PN information and the MIC information are located after BAR information and padding required by a recipient is carried after the MIC information. In some embodiments, the wireless device 300 is compatible with an Institute of Electrical and Electronics Engineers (IEEE) 802.11 protocol. In some embodiments, the wireless device includes a wireless multi-link device (MLD), the second communications device includes a second wireless MLD, and the wireless transceiver 302 is further configured to transmit the control frame for a wireless link to the second wireless MLD through the wireless link between the AP/STA of the wireless MLD in the wireless link and the STA/AP of the second wireless MLD in the wireless link.

Some implementations of protected multi-STA Block Acknowledgement (BA), for example, by the wireless communications system 100 depicted in FIG. 1, the multi-link (ML) communications system 200 depicted in FIG. 2, and/or the wireless device 300 depicted in FIG. 3 are described. In some embodiments, instead of defining a protected compressed BA frame by updating the frame format of a compressed BA frame, a protected Multi-STA BA is used to acknowledge an Aggregated Mac Protocol Data Unit (A-MPDU) with frames of single Traffic Identifier (TID) whose responding acknowledgment by using a compressed BA frame or a multi-TID BA frame requires the protection.

Some implementations of protected Power Save (PS)-Poll messages or frames, for example, by the wireless communications system 100 depicted in FIG. 1, the multi-link (ML) communications system 200 depicted in FIG. 2, and/or the wireless device 300 depicted in FIG. 3 are described. In some embodiments, the PS-Poll frame is not protected. In an attack analysis, for a STA that wakes up through a listening interval, an attacker can transmit a PS-Poll message or frame before the STA's awaking to ask a corresponding AP to transmit buffered frames for the STA. Consequently, when the STA wakes up, the AP may have no buffered frames for it because the AP has discarded the buffered frames for the STA. In some embodiments, for PS-Poll protection, a control frame protection field is carried before a frame check sequence (FCS). The indication of protected PS-Poll can be done through a protected frame subfield in a frame control field. In some embodiments, a protected PS-Poll is carried in an Ultra High Reliability (UHR) physical layer protocol data unit (PPDU), for example, to avoid the confusion of the non-UHR STAs. In some embodiments, each UHR STA/AP that supports the control frame protection needs to support UAPSD (unscheduled automatic power save delivery). In some embodiments, if the control frame protection is required by a STA, the STA transmits the UAPSD trigger frame with MAC header protection, for example, a QoS Null frame with MAC header protection, a QoS Data frame with MAC header protection, and/or a management frame with MAC header protection. In some embodiments, the STA is not allowed to transmit a PS-Poll frame instead the UAPSD trigger frame with MAC header protection is used.

Some implementations of protected and unprotected control frames, for example, by the wireless communications system 100 depicted in FIG. 1, the multi-link (ML) communications system 200 depicted in FIG. 2, and/or the wireless device 300 depicted in FIG. 3 are described.

In some embodiments, in a first option, when a Transmit opportunity (TXOP) holder and a responder enable control frame protection, frames, such as, an Acknowledgement (Ack) frame, a compressed BA frame, a multi-TID BA frame, a Request to Send (RTS) frame, and a PS-Poll frame are not allowed between the TXOP holder and the responder. In some embodiments, when a TXOP holder and a responder enable control frame protection, frames, such as, various trigger frames, at least one multi-STA BA frame, at least one compressed BAR frame, and at least one multi-TID BAR frame are protected between the TXOP holder supporting control frame protection and the responder supporting control frame protection. In some embodiments, the UAPSD trigger frame with MAC header protection, e.g., a QoS Null frame with MAC header protection, is used to replace a PS-Poll frame. In some embodiments, when a TXOP holder and a responder enable control frame protection, frames, such as, null data packet (NDP) announcement frames, contention-free (CF)-End frames, and Clear to Send (CTS) frames, do not need to be protected between the TXOP holder and the responder.

In some embodiments, in a second option, when a TXOP holder and a responder enable control frame protection, frames, such as, an Acknowledgement (Ack) frame, a compressed BA frame, a multi-TID BA frame, and/or a Request to Send (RTS) frame are not allowed between the TXOP holder and the responder. In some embodiments, when a TXOP holder and a responder enable control frame protection, frames, such as, various trigger frames, multi-STA BA frame, at least one compressed BAR frame, and at least one multi-TID BAR frame are protected between the TXOP holder and the responder. In some embodiments, when a TXOP holder and a responder enable control frame protection, frames, such as, NDP announcement frames, CF-End frames, CTS frames, and PS-Poll frames do not need to be protected between the TXOP holder and the responder.

In some embodiments, in a third option, when a TXOP holder and a responder enable control frame protection, frames, such as, an Acknowledgement (Ack) frame, a compressed BA frame, a multi-TID BA frame, a RTS frame, and a PS-Poll frame are not allowed between the TXOP holder and the responder. In some embodiments, when a TXOP holder and a responder enable control frame protection, frames, such as, various trigger frames, at least one multi-STA BA frame, at least one compressed BAR frame, at least one multi-TID BAR frame, and NDP announcement frames are protected between the TXOP holder and the responder. In some embodiments, the UAPSD trigger frame with MAC header protection, e.g., a QoS Null frame with MAC header protection, is used to replace a PS-Poll frame. In some embodiments, when a TXOP holder and a responder enable control frame protection, frames, such as, CF-End frames and CTS frames, do not need to be protected between the TXOP holder and the responder.

Some implementations of protected control frame indication, for example, by the wireless communications system 100 depicted in FIG. 1, the multi-link (ML) communications system 200 depicted in FIG. 2, and/or the wireless device 300 depicted in FIG. 3 are described.

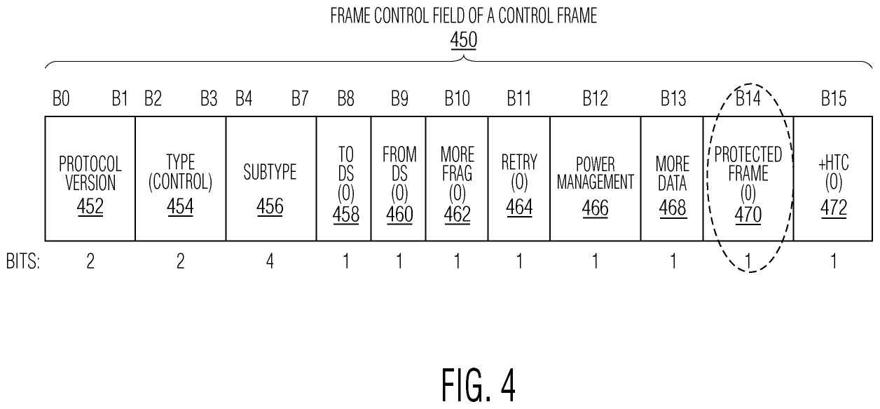

In some embodiments, a protected control frame has a protected frame subfield in its frame control field being set to a fixed value, for example, 1. FIG. 4 illustrates a frame control field format 450 of a protected control frame in accordance with an embodiment of the invention. The frame control field format 450 illustrated in FIG. 4 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 4, the frame control field format 450 includes a protocol version subfield 452 (e.g., two-bit) that may contain protocol version information, a type control subfield 454 (e.g., two-bit) that may contain type control information, a subtype subfield 456 (e.g., four-bit) that may contain subtype information, a To Distribution System (DS) subfield 458 (e.g., one-bit) that may contain to DS information, a From DS subfield 460 (e.g., one-bit) that may contain from DS information, a more fragmentation subfield 462 (e.g., one-bit) that may contain fragmentation information, a retry subfield 464 (e.g., one-bit) that may contain retry information, a power management subfield 466 (e.g., one-bit) that may contain power management information, a more data subfield 468 (e.g., one-bit) that may contain additional data information, a protected frame subfield 470 (e.g., one-bit) that may contain frame protection information, and a +HTC (High-Throughput Control) subfield 472 (e.g., one-bit) that may contain high-throughput control information. In some embodiments, the frame control field format 450 contains one or more additional subfield with additional information.

In some embodiments, in a variant, one current reserved bit in the frame body of a control frame is used to indicate whether the control frame is a protected control frame. Some examples of this variant are described as follows.

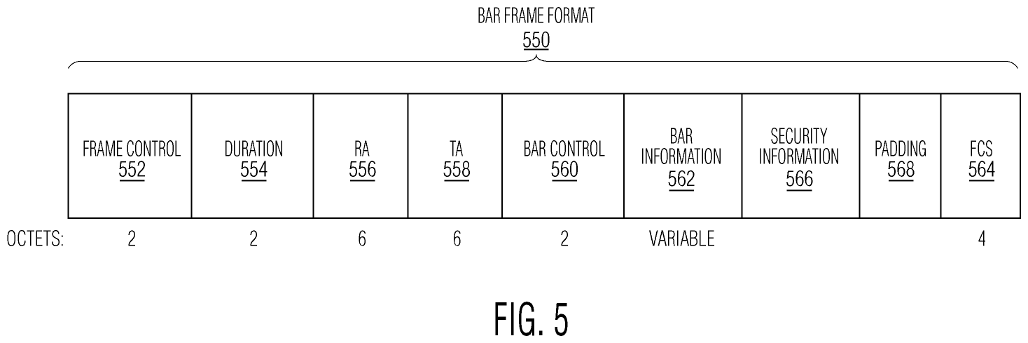

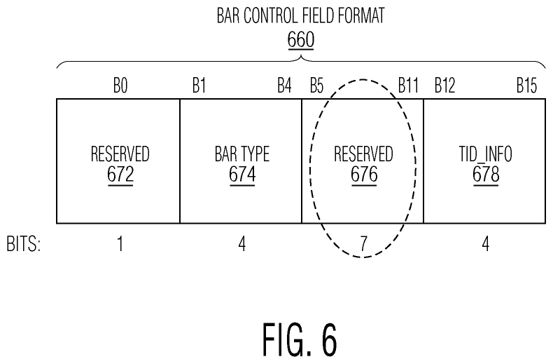

In some embodiments, one current reserved bit in the BAR control field of a BAR frame, i.e., one current reserved bit in the BAR control field of the BAR frame compatible with an IEEE 802.11be protocol, is used/repurposed to indicate whether the BAR frame is a protected BAR frame. FIG. 5 illustrates a BAR frame format 550 in accordance with an embodiment of the invention. The BAR frame format 550 illustrated in FIG. 5 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 5, the BAR frame format 550 includes a frame control field 552 (e.g., two-octet) that may contain frame control information, a frame duration field 554 (e.g., two-octet) that may contain frame duration information, a RA (receiver address) field 556 (e.g., six-octet) that may contain RA address information, a TA (transmitter address) field 558 (e.g., six-octet) that may contain TA address information, a BAR control field 560 (e.g., two-octet) that may contain BAR control information, a BAR information field 562 (e.g., variable length) that may contain BAR information, a security information field 566 that may contain the Security information of PN+MIC and may be located right after BAR information field 562, a padding field 568 that may contain Padding information (if required by the recipient) and may be located right after the Security information field 566, and a FCS field 564 (e.g., four-octet) that may contain FCS information. FIG. 6 illustrates a BAR control field format 660 in accordance with an embodiment of the invention, which is an embodiment of the BAR control field 560 illustrated in FIG. 5. The BAR control field format 660 illustrated in FIG. 6 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 6, the BAR control field format 660 includes a reserved subfield 672 (e.g., one-bit) that may contain reserved information, a BAR type subfield 674 (e.g., four-bit) that may contain BAR type information, a reserved subfield 676 (e.g., seven-bit) that currently contains reserved information compatible with an IEEE 802.11be protocol and is repurposed as the protected control frame indication to indicate whether the control frame is a protected frame, and a TID INFO subfield 678 (e.g., four-bit) that may contain TID information.

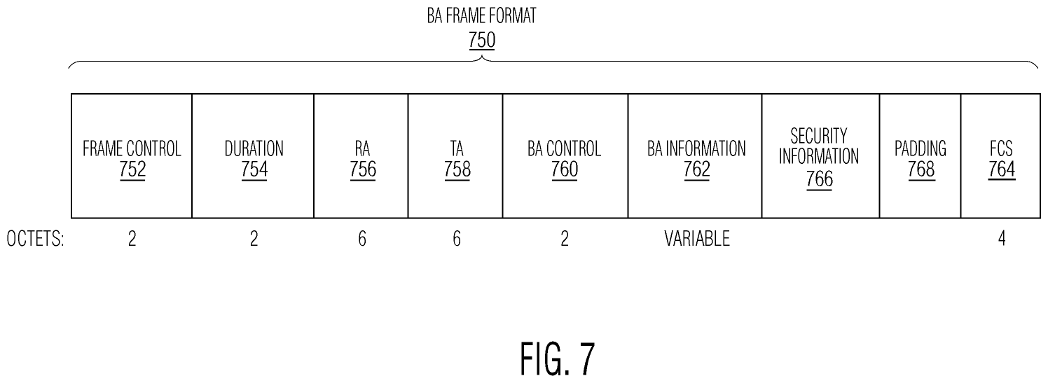

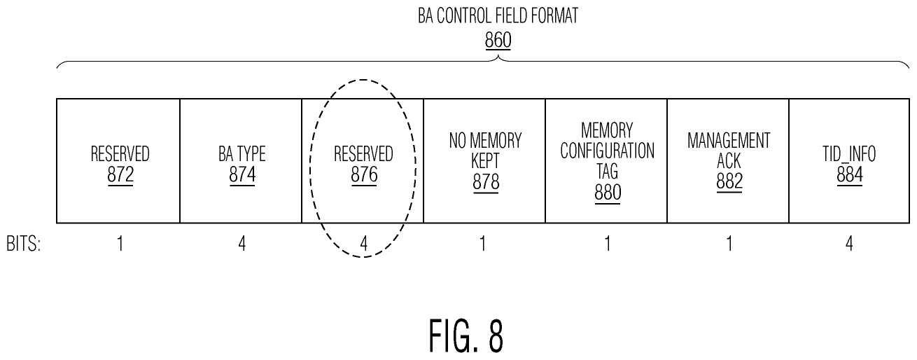

In some embodiments, one current reserved bit in a BA Control field of a BA frame defined by an IEEE 802.11be protocol is used/repurposed to indicate whether the BA frame is a protected BA frame. FIG. 7 illustrates a BA frame format 750 in accordance with an embodiment of the invention. The BA frame format 750 illustrated in FIG. 7 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 7, the BA frame format 750 includes a frame control field 752 (e.g., two-octet) that may contain frame control information, a frame duration field 754 (e.g., two-octet) that may contain frame duration information, a RA (receiver address) field 756 (e.g., six-octet) that may contain RA address information, a TA (transmitter address) field 758 (e.g., six-octet) that may contain TA address information, a BA control field 760 (e.g., two-octet) that may contain BA control information, a BA information field 762 (e.g., variable length) that may contain BA information, a security information field 766 that may contain the Security information of PN+MIC in a Per AID TID Info field with special value in its AID11 subfield and may be located right after the BA information field 762, a padding field 768 that may contain Padding information in one or multiple Per AID TID Info fields with special value in their AID11 fields right (if required by the recipient) and may be located after the Security information field 766, and a FCS field 764 (e.g., four-octet) that may contain FCS information. FIG. 8 illustrates a BA control field format 860 in accordance with an embodiment of the invention, which is an embodiment of the BA control field 760 illustrated in FIG. 7. The BA control field format 860 illustrated in FIG. 8 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 8, the BA control field format 860 includes a reserved subfield 872 (e.g., one-bit) that may contain reserved information, a BA type subfield 874 (e.g., four-bit) that may contain BA type information, a reserved subfield 876 whose one bit currently contains reserved information compatible with an IEEE 802.11be protocol and is repurposed as the protected control frame indication to indicate whether the control frame is a protected frame, a No Memory Kept subfield 878 (e.g., one-bit) that may contain memory information, a memory configuration tag subfield 880 (e.g., one-bit) that may contain memory configuration tag information, a management Ack subfield 882 (e.g., one-bit) that may contain management acknowledgement information, and a TID INFO subfield 884 (e.g., four-bit) that may contain TID information.

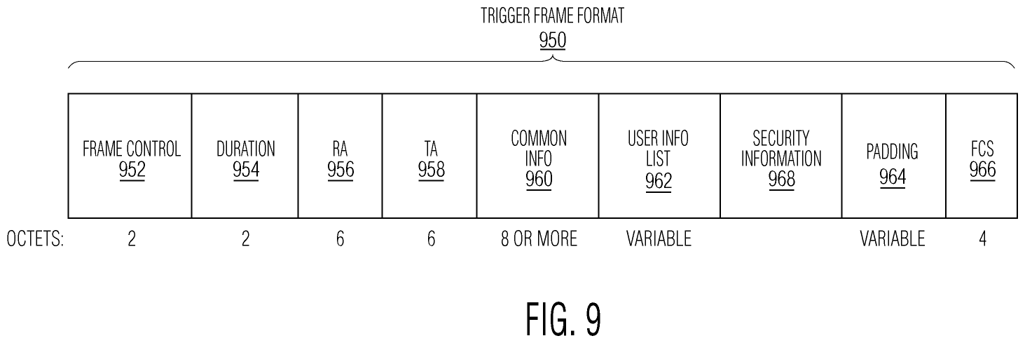

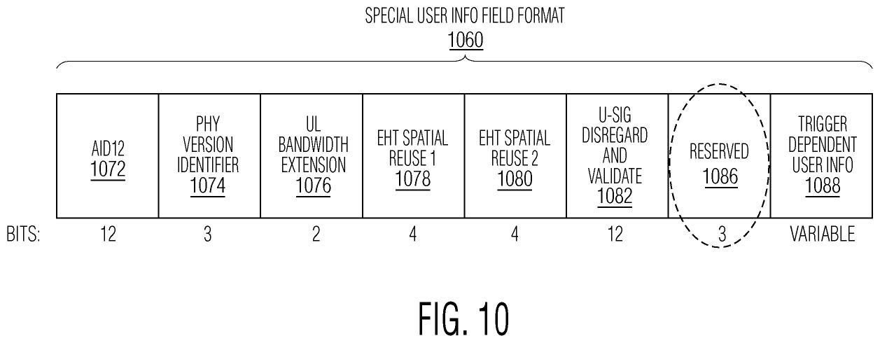

In some embodiments, one current reserved bit in a Special User Info field or a Common Info field of a trigger frame defined by an IEEE 802.11be protocol is used to indicate whether the trigger frame is a protected trigger frame. FIG. 9 illustrates a trigger frame format 950 in accordance with an embodiment of the invention. The trigger frame format 950 illustrated in FIG. 9 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 9, the trigger frame format 950 includes a frame control field 952 (e.g., two-octet) that may contain frame control information, a frame duration field 954 (e.g., two-octet) that may contain frame duration information, a RA (receiver address) field 956 (e.g., six-octet) that may contain RA address information, a TA (transmitter address) field 958 (e.g., six-octet) that may contain TA address information, a Common Info field 960 (e.g., eight-octet or more) that may contain common information, a User Info List field 962 (e.g., variable length) that may contain user information with Special User Info field for all addressed STA(s) and User Info field(s) addressed to specific STA(s), a security information field 968 that may contain the Security information of PN+MIC and may be located right after the User Info List field 962, a padding field 964 that may contain the Pre-Padding FCS information right (if required by the recipient) and may be located after the Security information field 968, and a FCS field 966 (e.g., four-octet) that may contain FCS information. In some embodiments, the pre-padding FCS is not carried in a Trigger frame when MIC is carried in the Trigger frame and all addressed STAs of the Trigger frame need to check the FCS. In some embodiments, the trigger frame format 950 includes a Special User Info field that may contain special user information for all STAs addressed by the Trigger frame. FIG. 10 illustrates a Special User Info field format 1060 in accordance with an embodiment of the invention. The Special User Info field format 1060 illustrated in FIG. 10 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 10, the Special User Info field format 1060 includes an Association ID (AID) 12 subfield 1072 (e.g., twelve-bit) with special AID value 2007 to identify the Special User Info field, a PHY Version Identifier subfield 1074 (e.g., three-bit) that may contain physical version identifier information, a UL Bandwidth Extension subfield 1076 (e.g., two-bit) that may contain uplink (UL) bandwidth extension information, an Extremely High Throughput (EHT) Spatial Reuse 1 subfield 1078 (e.g., four-bit) that may contain EHT spatial re-use information, an EHT Spatial Reuse 2 subfield 1080 (e.g., four-bit) that may contain additional EHT spatial re-use information, an Universal Signal Field (U-SIG) Disregard and Validate subfield 1082 (e.g., twelve-bit) that may contain U-SIG disregard and validation information, a reserved subfield 1086 (e.g., three-bit) whose one bit currently contains reserved information compatible with an IEEE 802.11be protocol and is repurposed as the protected control frame indication to indicate whether the control frame is a protected frame, and a Trigger Dependent User Info subfield 1088 (e.g., variable length) that may contain trigger dependent user information. In some embodiments, one current reserved bit in a Common Info field of a trigger frame (e.g., the trigger frame format 950) compatible with an IEEE 802.11be protocol is used/repurposed to indicate whether the trigger frame is a protected trigger frame.

Some implementations of key indication of a protected control frame, for example, by the wireless communications system 100 depicted in FIG. 1, the multi-link (ML) communications system 200 depicted in FIG. 2, and/or the wireless device 300 depicted in FIG. 3 are described.

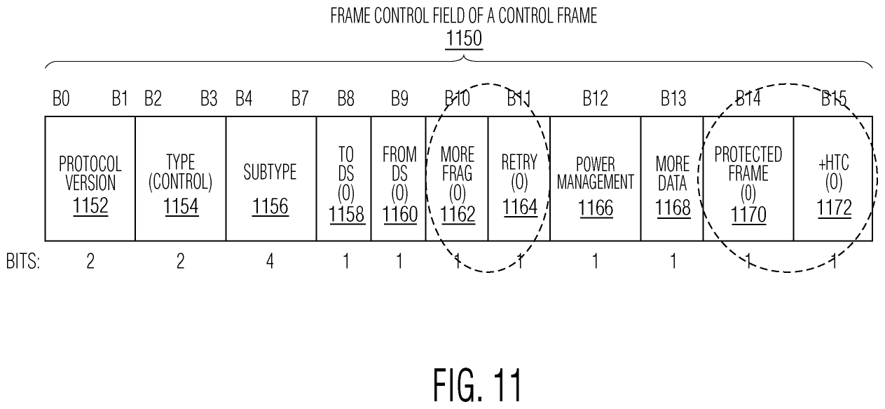

In some embodiments, in a first option 1, the Key identification (ID) information (also referred to as key ID) of a protected control frame is indicated in IEEE 802.11be's one or two current reserved bits of the frame control field of the control frame by repurposing the current reserved bit(s) to carry the Key ID. In some embodiments, at most two control frame peer transient key (CPTK) keys may exist simultaneously. FIG. 11 illustrates a frame control field format 1150 of a protected control frame in accordance with an embodiment of the invention. The frame control field format 1150 illustrated in FIG. 11 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 11, the frame control field format 1150 includes a protocol version subfield 1152 (e.g., two-bit) that may contain protocol version information, a type control subfield 1154 (e.g., two-bit) that may contain type control information, a subtype subfield 1156 (e.g., four-bit) that may contain subtype information, a To Distribution System (DS) subfield 1158 (e.g., one-bit) that may contain to DS information, a From DS subfield 1160 (e.g., one-bit) that may contain from DS information, a more fragmentation subfield 1162 (e.g., one-bit) that currently contains reserved information for control frame compatible with an IEEE 802.11be protocol and is repurposed as the Key ID to indicate the key identifier for protecting the control frame as one option, a retry subfield 1164 (e.g., one-bit) that may contain retry information and the Key ID of the protected control frame, a power management subfield 1166 (e.g., one-bit) that may contain power management information, a more data subfield 1168 (e.g., one-bit) that may contain additional data information, a protected frame subfield 1170 (e.g., one-bit) that currently contains reserved information for control frame compatible with an IEEE 802.11be protocol and is repurposed as the Key ID to indicate the key identifier for protecting the control frame as another option, and a +HTC (High-Throughput Control) subfield 1172 (e.g., one-bit) that currently contains reserved information for control frame compatible with an IEEE 802.11be protocol and is repurposed as the Key ID to indicate the key identifier for protecting the control frame as the third option. In some embodiments, the frame control field format 1150 contains one or more additional subfield with additional information.

In some embodiments, in a variant, IEEE 802.11be's one or more reserved bits in the frame body of a control frame (e.g., a protected control frame) are used/repurposed to indicate the key ID of the control frame (e.g., the protected control frame). Some examples of this variant are described as follows.

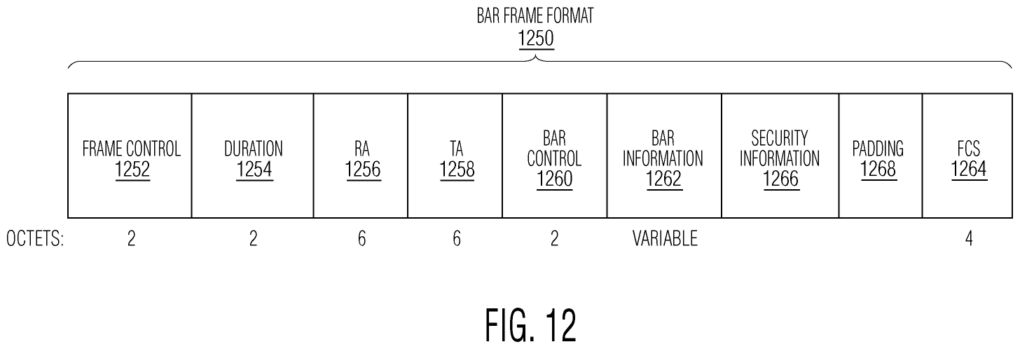

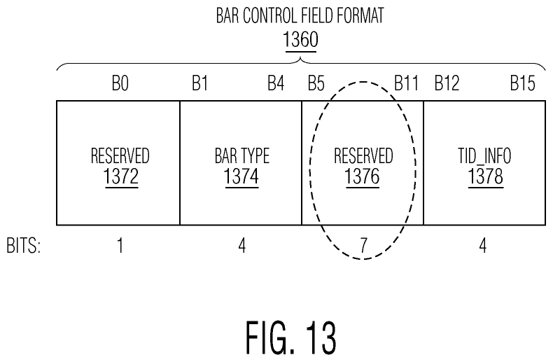

In some embodiments, IEEE 802.11be's one or two reserved bits in BAR control field of a BAR frame are repurposed/used to indicate the Key ID. In some embodiments, at most two control frame peer transient key (CPTK) keys may exist simultaneously. FIG. 12 illustrates a BAR frame format 1250 in accordance with an embodiment of the invention. The BAR frame format 1250 illustrated in FIG. 12 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 12, the BAR frame format 1250 includes a frame control field 1252 (e.g., two-octet) that may contain frame control information, a frame duration field 1254 (e.g., two-octet) that may contain frame duration information, a RA (receiver address) field 1256 (e.g., six-octet) that may contain RA address information, a TA (transmitter address) field 1258 (e.g., six-octet) that may contain TA address information, a BAR control field 1260 (e.g., two-octet) that may contain BAR control information (e.g., one or two reserved bits in BAR control field are used to indicate the Key ID), a BAR information field 1262 (e.g., variable length) that may contain BAR information, a security information field 1266 that may contain the Security information of PN+MIC and may be located right after the BAR information field 1262, a padding field 1268 that may contain the Padding information and may be located right (if required by the recipient) after the Security information field 1266, and a FCS field 1264 (e.g., four-octet) that may contain FCS information. FIG. 13 illustrates a BAR control field format 1360 in accordance with an embodiment of the invention, which is an embodiment of the BAR control field 1260 illustrated in FIG. 12. The BAR control field format 1360 illustrated in FIG. 13 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 13, the BAR control field format 1360 includes a reserved subfield 1372 (e.g., one-bit) that may contain reserved information, a BAR type subfield 1374 (e.g., four-bit) that may contain BAR type information, a reserved subfield 1376 (e.g., seven-bit) whose one bit currently contains the reserved information for the control frame compatible with an IEEE 802.11be protocol and is repurposed as the Key ID to indicate the key identifier for protecting the control frame, and a TID INFO subfield 1378 (e.g., four-bit) that may contain TID information.

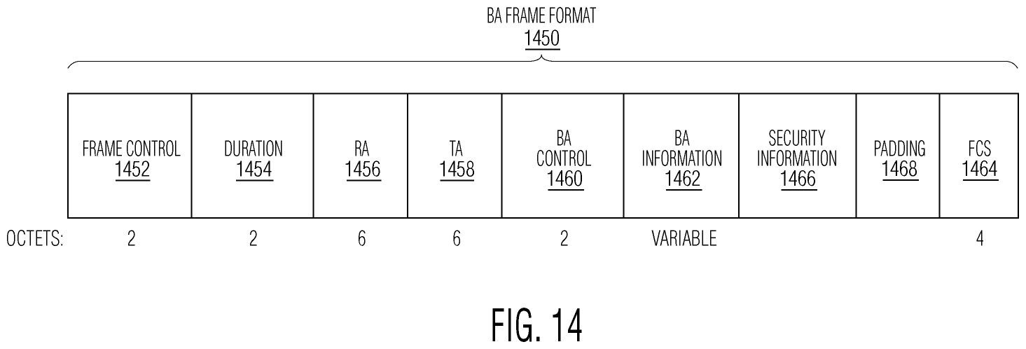

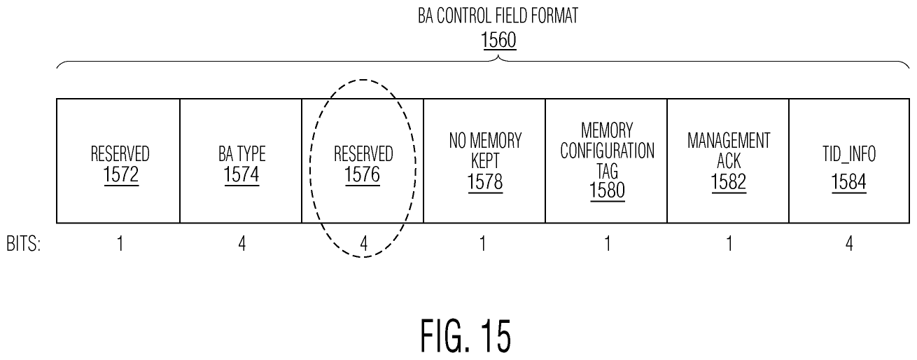

In some embodiments, one or two current reserved bits in BA control field of a BA frame are repurposed/used to indicate the Key ID. In some embodiments, at most two CPTK keys may exist simultaneously. FIG. 14 illustrates a BA frame format 1450 in accordance with an embodiment of the invention. The BA frame format 1450 illustrated in FIG. 14 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 14, the BA frame format 1450 includes a frame control field 1452 (e.g., two-octet) that may contain frame control information, a frame duration field 1454 (e.g., two-octet) that may contain frame duration information, a RA (receiver address) field 1456 (e.g., six-octet) that may contain RA address information, a TA (transmitter address) field 1458 (e.g., six-octet) that may contain TA address information, a BA control field 1460 (e.g., two-octet) that may contain BA control information (e.g., one or two reserved bits that are used to indicate the Key ID), a BA information field 1462 (e.g., variable length) that may contain BA information, a security information field 1466 that may contain the Security information of PN+MIC and may be located right after the BA information field 1462, a padding field 1468 that may contain the Padding information right (if required by the recipient) and may be located after the Security information field 1466, and a FCS field 1464 (e.g., four-octet) that may contain FCS information. FIG. 15 illustrates a BA control field format 1560 in accordance with an embodiment of the invention, which is an embodiment of the BA control field 1460 illustrated in FIG. 14. The BA control field format 1560 illustrated in FIG. 15 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 15, the BA control field format 1560 includes a reserved subfield 1572 (e.g., one-bit) that may contain reserved information, a BA type subfield 1574 (e.g., four-bit) that may contain BA type information, a reserved subfield 1576 (e.g., four-bit) whose one-bit currently contains the reserved information for the control frame in an 802.11be protocol and is repurposed as the Key ID to indicate the key identifier for protecting the control frame, a No Memory Kept subfield 1578 (e.g., one-bit) that may contain memory information, a memory configuration tag subfield 1580 (e.g., one-bit) that may contain memory configuration tag information, a management Ack subfield 1582 (e.g., one-bit) that may contain management acknowledgement information, and a TID INFO subfield 1584 (e.g., four-bit) that may contain TID information.

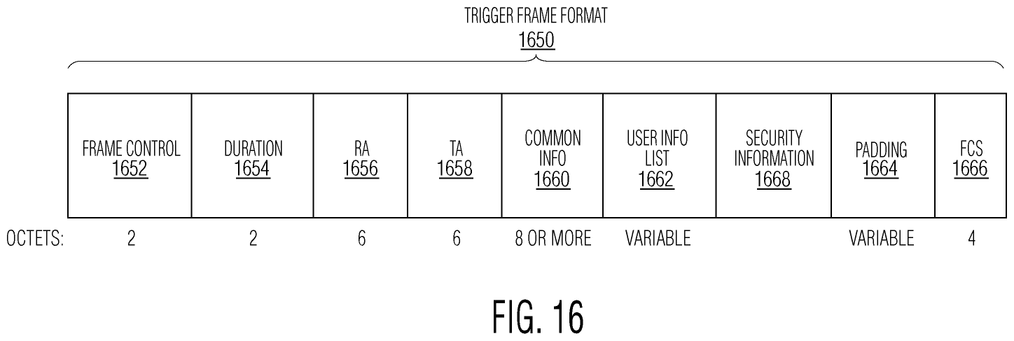

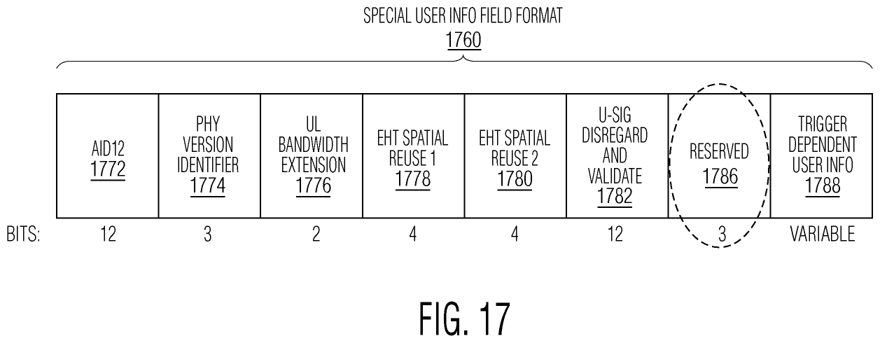

In some embodiments, one or two reserved bits in Common Info field or Special User Info field of a protected Trigger frame are used to indicate the Key ID. In some embodiments, at most two CPTK keys may exist simultaneously. FIG. 16 illustrates a trigger frame format 1650 in accordance with an embodiment of the invention. The trigger frame format 1650 illustrated in FIG. 16 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 16, the trigger frame format 1650 includes a frame control field 1652 (e.g., two-octet) that may contain frame control information, a frame duration field 1654 (e.g., two-octet) that may contain frame duration information, a RA (receiver address) field 1656 (e.g., six-octet) that may contain RA address information, a TA (transmitter address) field 1658 (e.g., six-octet) that may contain TA address information, a Common Info field 1660 (e.g., eight-octet or more) that may contain common information, a User Info List field 1662 (e.g., variable length) that may contain user information with Special User Info field for all addressed STA(s) and User Info field(s) addressed to specific STA(s), a security information field 1668 that may contain the Security information of PN+MIC and may be located right after the User Info List field 1662, a padding field 1664 (e.g., variable length) that may contain the Pre-Padding FCS information and may be located right (if required by the recipient) after the Security information field 1668, and a FCS field 1666 (e.g., four-octet) that may contain FCS information. In some embodiments, the pre-padding FCS is not carried in a Trigger frame when MIC is carried in the Trigger frame and all addressed STAs of the Trigger frame need to check the FCS. In some embodiments, the trigger frame format 1650 includes a Special User Info field as the first User Info field of User Info List field 1662 that may contain IEEE 802.11be's one bit (or two reserved bits) that is used/repurposed to indicate the Key ID. FIG. 17 illustrates a Special User Info field format 1760 in accordance with an embodiment of the invention. The Special User Info field format 1760 illustrated in FIG. 17 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 17, the Special User Info field format 1760 includes an AID12 subfield 1772 (e.g., twelve-bit) that may contain AID information, a PHY Version Identifier subfield 1774 (e.g., three-bit) that may contain physical version identifier information, a UL Bandwidth Extension subfield 1776 (e.g., two-bit) that may contain UL bandwidth extension information, an EHT Spatial Reuse 1 subfield 1778 (e.g., four-bit) that may contain EHT spatial re-use information, an EHT Spatial Reuse 2 subfield 1780 (e.g., four-bit) that may contain additional EHT spatial re-use information, an U-SIG Disregard and Validate subfield 1782 (e.g., twelve-bit) that may contain U-SIG disregard and validation information, a reserved subfield 1786 (e.g., three-bit) whose one-bit or two-bit currently contains the reserved information for the control frame as defined compatible with an IEEE 802.11be protocol and is repurposed as the Key ID to indicate the key identifier for protecting the control frame, and a Trigger Dependent User Info subfield 1788 (e.g., variable length) that may contain trigger dependent user information. In some embodiments, one current reserved bit or two current reserved bits in a Common Info field of a trigger frame (e.g., the trigger frame format 1650) compatible with an IEEE 802.11be protocol is/are used/repurposed as the Key ID to indicate the key identifier for protecting the control frame.

In some embodiments, the field with packet number (PN) and message integrity check (MIC) is located in a separate location, e.g., before padding if padding exists and intermediate FCS does not exist, before intermediate FCS (pre-padding FCS) if intermediate FCS exists, or before FCS if padding and intermediate FCS do not exist. In some embodiments, the intermediate FCS is not carried in a Trigger frame when MIC is carried in the Trigger frame and all addressed STAs of the Trigger frame need to check the FCS.

In some embodiments, in a second option, the Key ID is combined with PN in one field.

In some embodiments, in a third option, the Key ID is carried together with PN and MIC in a security information field, e.g., before padding if padding exists and intermediate FCS does not exist, before intermediate FCS (pre-padding FCS) if intermediate FCS exists, or before FCS if padding and intermediate FCS do not exist.

Some implementations of PN of Protected Control Frame when PN is separated from MIC, for example, by the wireless communications system 100 depicted in FIG. 1, the multi-link (ML) communications system 200 depicted in FIG. 2, and/or the wireless device 300 depicted in FIG. 3 are described. In some embodiments, the PN is placed as follows. In a trigger frame, the PN is before the User Info field(s) for the specific STAs. The PN may be located right after the Special User Info field, e.g., the PN is carried in the User Info field(s) with specific AID value, e.g., 2006. In a Multi-STA BA, the PN is right after BA Control field. The PN may be carried in the Per AID TID field with specific AID value, e.g. 2006, in an AID11 subfield. In some embodiments, in a compressed BAR and a multi-TID BAR, the PN is located right after a BAR Control field.

Some implementations of Protected compressed BAR and/or Multi-TID BAR, for example, by the wireless communications system 100 depicted in FIG. 1, the multi-link (ML) communications system 200 depicted in FIG. 2, and/or the wireless device 300 depicted in FIG. 3 are described. In some embodiments, in a first option, the Key ID is carried in one of the current reserved bits (as defined in an IEEE 802.11be protocol) of the BAR Control field of the compressed Block Ack Request (CBAR), Multi-TID BAR. In some embodiments, in another variant, the explicit indication of whether the CBAR and Multi-TID BAR is protected or not is also carried in the current reserved bits (as defined in an IEEE 802.11be protocol) of the BAR Control field. In some embodiments, the 6-octet PN and 16-byte MIC (or 8-byte MIC with the length is an example) where PN is before MIC is before the padding field if padding field exists, or before FCS if padding does not exist. In some embodiments, the padding field has all Is. In some embodiments, in a second option, the Key ID and PN, MIC are located after a BAR Information field.

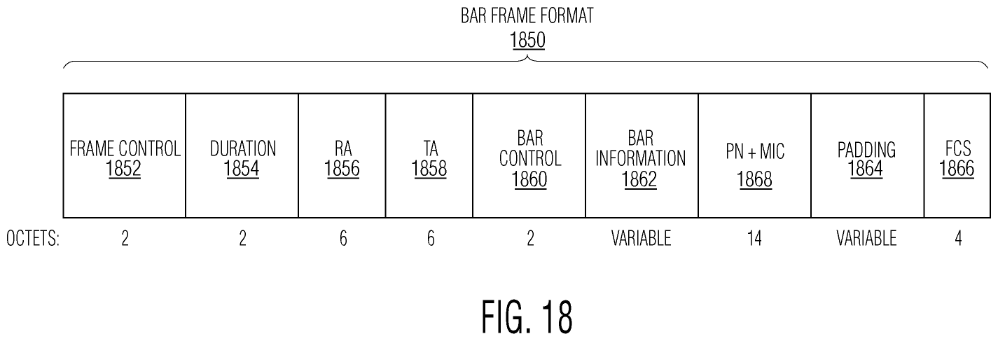

FIG. 18 illustrates a BAR frame format 1850 in accordance with an embodiment of the invention. The BAR frame format 1850 illustrated in FIG. 18 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 18, the BAR frame format 1850 includes a frame control field 1852 (e.g., two-octet) that may contain frame control information, a frame duration field 1854 (e.g., two-octet) that may contain frame duration information, a RA (receiver address) field 1856 (e.g., six-octet) that may contain RA address information, a TA (transmitter address) field 1858 (e.g., six-octet) that may contain TA address information, a BAR control field 1860 (e.g., two-octet) that may contain BAR control information, a BAR information field 1862 (e.g., variable length) that may contain BAR information, a PN+MIC field 1868 (e.g., 22-octet or fourteen-octet) that may contain PN and MIC information, a padding field 1864 (e.g., variable length) that may contain padding information, and a FCS field 1866 (e.g., four-octet) that may contain FCS information.

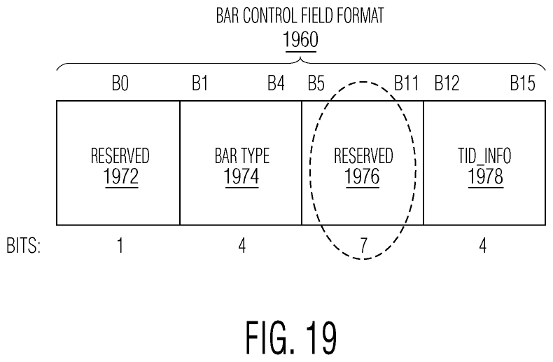

FIG. 19 illustrates a BAR control field format 1960 in accordance with an embodiment of the invention, which is an embodiment of the BAR control field 1860 illustrated in FIG. 18. The BAR control field format 1960 illustrated in FIG. 19 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 19, the BAR control field format 1960 includes a reserved subfield 1972 (e.g., one-bit) that may contain reserved information, a BAR type subfield 1974 (e.g., four-bit) that may contain BAR type information, a reserved subfield 1976 (e.g., seven-bit) whose one bit contains reserved information currently as defined in an IEEE 802.11be protocol and is repurposed/used to indicate whether the frame is protected or not and whose another bit contains reserved information currently as defined in an IEEE 802.11be protocol and is repurposed/used to indicate Ley ID, and a TID INFO subfield 1978 (e.g., four-bit) that may contain TID information.

Some implementations of protected trigger frames, for example, by the wireless communications system 100 depicted in FIG. 1, the multi-link (ML) communications system 200 depicted in FIG. 2, and/or the wireless device 300 depicted in FIG. 3 are described. In some embodiments, in a first option, the indication about whether the control frame is protected is carried in one of the current reserved bits (as defined in an IEEE 802.11be protocol) of a Common Info field or one of the current reserve bits (as defined in an IEEE 802.11be protocol) of a Special User Info field. In some embodiments, the Key ID is carried in one of the current reserved bits (as defined in an IEEE 802.11be protocol) of a Common Info field or one of the current reserve bits (as defined in an IEEE 802.11be protocol) of a Special User Info field. In some embodiments, the PN and MIC are carried in several Secure User Info fields. In some embodiments, the Secure User Info fields are located after User Info fields addressed to specific STAs. In some embodiments, each Secure User Info field has a special value (e.g., 2009) in its AID12 field. In some embodiments, in a Trigger frame where the User Info fields have the same length, each Security User Info field has the same length as the User Info field, which also means that the Security User Info field has the same length as the Special User Info field. In some embodiments, in a Basic Trigger frame and in a Beamforming Report Poll (BFRP) Trigger frame, each Security User Info field has one-octet Trigger Dependent User Info subfield that is reserved. In some embodiments, in the other variant Trigger frame whose User Info fields addressed to specific STAs have the same length, there is no Trigger Dependent User Info subfield in each Security User Info field. In some embodiments, in a Trigger frame where the User Info fields may have the different lengths, i.e., in a multi-user (MU)-BAR frame, the Security User Info field has the Trigger Dependent User Info subfield. In some embodiments, the length of the Trigger Dependent User Info subfield is four octets and all the subfields in the Trigger Dependent User Info subfield, except for the BAR Type subfield, are reserved. In some embodiments, the BAR Type subfield is set to indicate a Compressed BAR in an MU BAR Trigger frame, which means that the Security User Info field has the same length as the Special User Info field. In some embodiments, the Security Info subfield of each Security User Info field is used to carry 28 bits of the PN and MIC with the exception that the last Security User Info carries the remaining bits of the PN and MIC. In some embodiments, the Security Info subfield of each Security User Info field is used to carry 32 bits of the PN and MIC with the exception that the last Security User Info carries the remaining bits of the PN and MIC. In such embodiments, each Secure User Info field has a special value in its AID12 field with its most significant bit (MSB) equal to 1 and the 4-bit least significant bits (LSBs) of its AID12 field are used to carry the PN and MIC. In some embodiments, one variant is that the Security Info subfield of each Security User Info field is used to carry 24 bits of the PN and MIC where the last 4 bits of Security Info subfield is reserved with the exception that the last Security User Info field carries the remaining bits of the PN and MIC. In some embodiments, in a Trigger frame where the User Info fields have same length, each Pre-Padding FCS User Info field has the same length as the User Info field addressed to a specific STA (and also Special User Info field). In some embodiments, each Pre-Padding FCS User Info field has a special value in its AID12 field (e.g. 2016). In some embodiments, the Pre-Padding FCS User Info fields are located after Secure User Info fields. In some embodiments, in a Basic Trigger frame and in a BFRP Trigger frame, each Pre-Padding FCS User Info field has one-octet Trigger Dependent User Info subfield that is reserved. In some embodiments, in the other variant Trigger frame whose User Info fields have the same length, there is no Trigger Dependent User Info subfield in each Pre-Padding FCS User Info field. In some embodiments, in a Trigger frame where the User Info fields may have the different lengths, i.e., in a MU-BAR frame, the Pre-Padding FCS User Info field has the Trigger Dependent User Info subfield. In some embodiments, the length of the Trigger Dependent User Info subfield is four octets and all the subfields in the Trigger Dependent User Info subfield, except for the BAR Type subfield, are reserved. In some embodiments, the BAR Type subfield is set to indicate a Compressed BAR in an MU BAR Trigger frame. In some embodiments, the FCS Info subfield of the first Pre-Padding FCS User Info field is used to carry 28 bits of the FCS, and the FCS Info subfield of the second Pre-Padding FCS User Info field is used to carry the remaining 4 bits of the FCS. In some embodiments, the single Pre-Padding FCS User Info field is used to carry 32 bits of the pre-padding FCS (intermediate FCS). In such embodiments, the single Pre-Padding User Info field has a special value in its AID12 field with its MSB equal to 1 and the 4-bit LSBs of its AID12 field are used to carry the pre-padding FCS. In some embodiments, one variant is that the FCS Info subfield of the first Pre-Padding FCS User Info field is used to carry 24 bits of the FCS, and the FCS Info subfield of the second Pre-Padding FCS User Info field is used to carry the remaining 8 bits of the FCS. In some embodiments, the pre-padding FCS is carried after 16-bit Is in the Padding field while the PN+MIC is carried in Secure User Info fields.

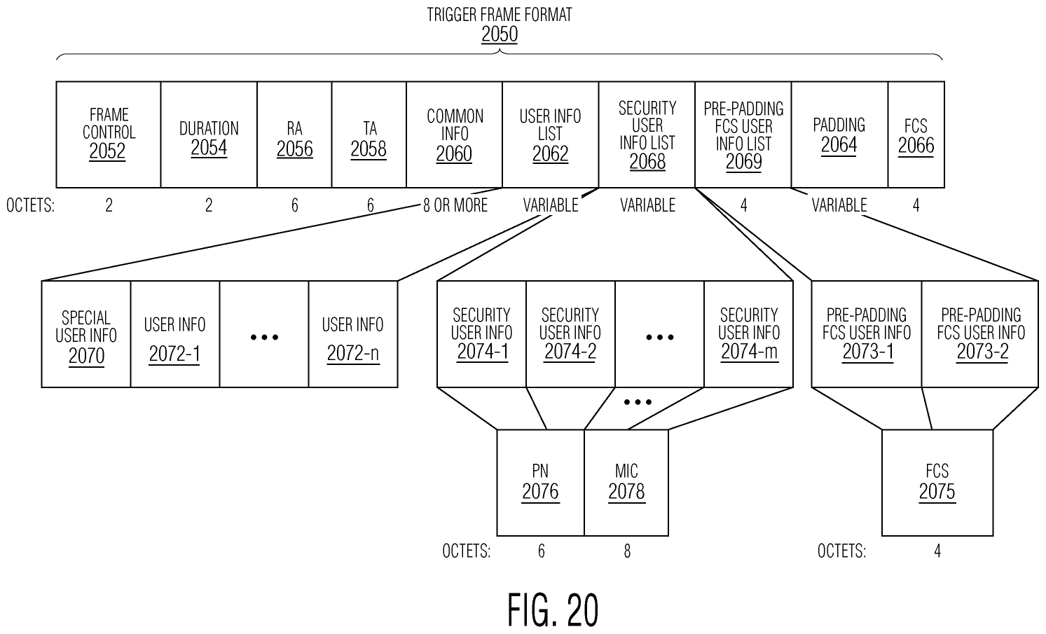

FIG. 20 illustrates a trigger frame format 2050 in accordance with an embodiment of the invention. The trigger frame format 2050 illustrated in FIG. 20 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 20, the trigger frame format 2050 includes a frame control field 2052 (e.g., two-octet) that may contain frame control information, a frame duration field 2054 (e.g., two-octet) that may contain frame duration information, a RA (receiver address) field 2056 (e.g., six-octet) that may contain RA address information, a TA (transmitter address) field 2058 (e.g., six-octet) that may contain TA address information, a Common Info field 2060 (e.g., eight-octet or more) that may contain common information, a User Info List field 2062 (e.g., variable length) that may contain user information, a security User Info List field 2068 (e.g., variable length) that may contain a security information, a Pre-padding FCS User Info List field 2069 (e.g., four-octet) that may contain a pre-padding FCS if the pre-padding is required by at least one the recipient, a padding field 2064 (e.g., variable length) that may contain padding information, and a FCS field 2066 (e.g., four-octet) that may contain FCS information. In some embodiments, if both a pre-padding FCS and PN+MIC are carried in a Trigger frame, the pre-padding FCS is located right after PN+MIC as shown in FIG. 20. The User Info List field 2062 may include a Special User Info subfield 2070 that may contain special user information for all addressed STAs and one or more User Info subfields 2072-1, . . . , 2072-n, where n is a positive integer, with each User Info field addressed to a specific STA. The security User Info List field 2068 may include multiple Security User Info fields 2074-1, . . . , 2074-m, where m is a positive integer, which may contain user security information. In some embodiments, at least one of the Security User Info fields 2074-1, . . . , 2074-m includes a PN subfield 2076 (e.g., six-octet) that may contain packet number (PN) information and a MIC subfield 2078 (e.g., eight-octet) that may contain message integrity check (MIC) information. In some embodiments, the Pre-padding FCS User Info List field 2069 includes Pre-padding FCS User Info fields 2073-1, 2073-2, which may contain pre-padding FCS user information. In some embodiments, at least one of the Pre-padding FCS User Info fields 2073-1, 2073-2 contains user information, such as, an FCS subfield 2075 (e.g., four-octet) that may contain frame check sequence (FCS) information. In some embodiments, at least one of the Pre-padding FCS User Info fields 2073-1, 2073-2 contains a pre-padding subfield that may contain pre-padding information.

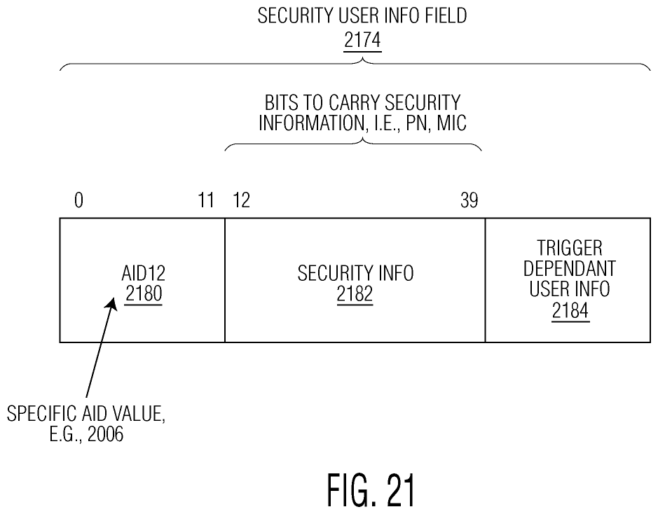

FIG. 21 illustrates a Security User Info field 2174 in accordance with an embodiment of the invention, which may be an embodiment of the Security User Info fields 2074-1, . . . , 2074-m illustrated in FIG. 20. The Security User Info field 2174 illustrated in FIG. 21 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 21, the Security User Info field 2174 includes an AID12 subfield 2180 (e.g., twelve-bit) that may contain a special AID value (for example, a specific AID value (e.g., 2006)) to identify the Security User Info field, a Security Info subfield 2182 (e.g., twenty eight-bit) that may contain security information (e.g., PN information and/or MIC information), and a Trigger Dependent User Info subfield 2184 that is reserved.

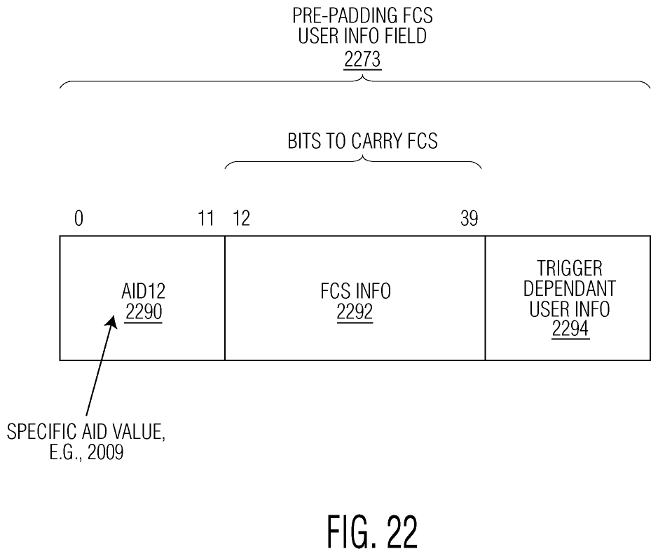

FIG. 22 illustrates a Pre-padding FCS User Info field 2273 in accordance with an embodiment of the invention, which may be an embodiment of the Pre-padding FCS User Info fields 2173-1, 2173-2 illustrated in FIG. 21. The Pre-padding FCS User Info field 2273 illustrated in FIG. 22 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 22, the Pre-padding FCS User Info field 2273 includes an AID12 subfield 2290 (e.g., twelve-bit) that may contain AID information (for example, a specific AID value (e.g., 2009)), an FCS Info subfield 2292 (e.g., twenty eight-bit) that may contain FCS information, and a Trigger Dependent User Info subfield 2294 that is reserved.

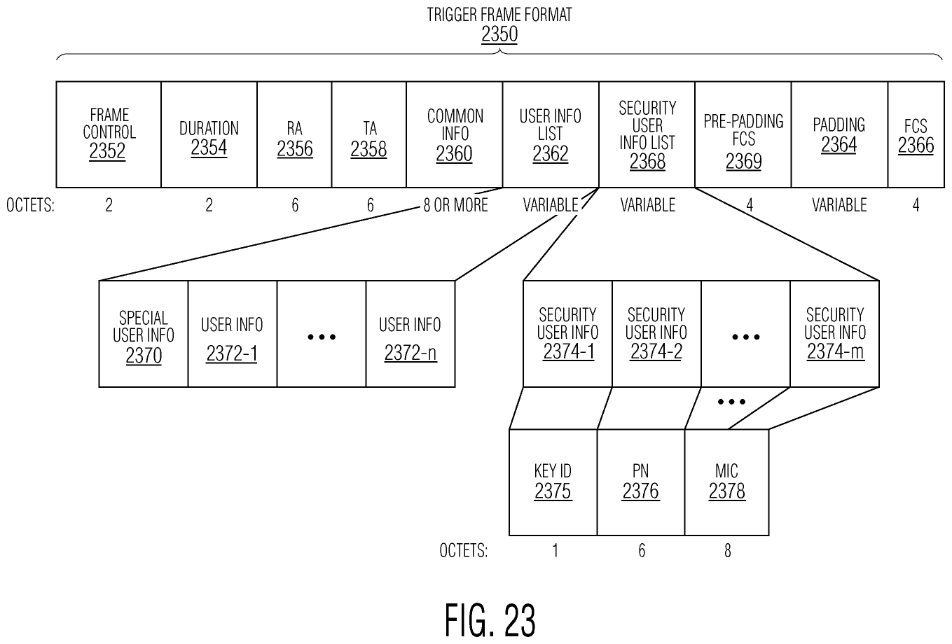

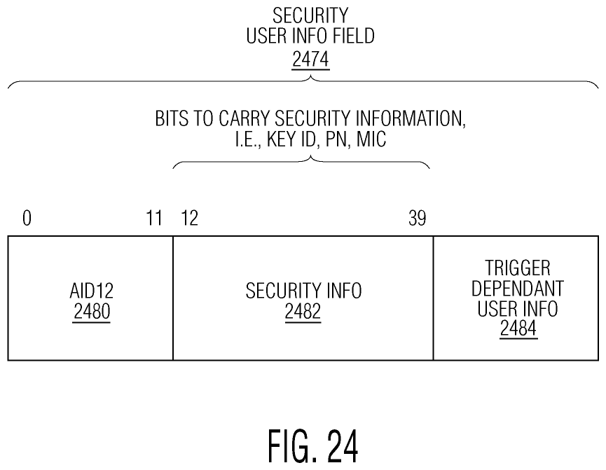

In some embodiments, in a second option, the Key ID is carried in Security User Info list. FIG. 23 illustrates a trigger frame format 2350 in accordance with an embodiment of the invention. The trigger frame format 2350 illustrated in FIG. 23 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 23, the trigger frame format 2350 includes a frame control field 2352 (e.g., two-octet) that may contain frame control information, a frame duration field 2354 (e.g., two-octet) that may contain frame duration information, a RA (receiver address) field 2356 (e.g., six-octet) that may contain RA address information, a TA (transmitter address) field 2358 (e.g., six-octet) that may contain TA address information, a Common Info field 2360 (e.g., eight-octet or more) that may contain common information, a User Info List field 2362 (e.g., variable length) that may contain user information, a security User Info List field 2368 (e.g., variable length) that may contain a security user information list, a Pre-padding FCS User Info List field 2369 that may contain a pre-padding FCS user information list for four-octet pre-padding FCS, a padding field 2364 (e.g., variable length) that may contain padding information, and a FCS field 2366 (e.g., four-octet) that may contain FCS information. The User Info List field 2362 may include a Special User Info subfield 2370 that may contain special user information and one or more User Info subfields 2372-1, . . . , 2372-n, where n is a positive integer, which may contain user information. The security User Info List field 2368 may include multiple Security User Info fields 2374-1, . . . , 2374-m, where m is a positive integer, which may contain user security information. In some embodiments, at least one of the Security User Info fields 2374-1, . . . , 2374-m includes a Key ID subfield 2375 (e.g., one-octet) that may contain key ID information, a PN subfield 2376 (e.g., six-octet) that may contain packet number (PN) information, and a MIC subfield 2378 (e.g., eight-octet) that may contain message integrity check (MIC) information. FIG. 24 illustrates a Security User Info field 2474 in accordance with an embodiment of the invention, which may be an embodiment of the Security User Info fields 2374-1, . . . , 2374-m illustrated in FIG. 23. The Security User Info field 2474 illustrated in FIG. 24 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 24, the Security User Info field 2474 includes an AID12 subfield 2480 (e.g., twelve-bit) that may contain AID information (for example, a specific AID value (e.g., 2006)), a Security Info subfield 2482 (e.g., twenty eight-bit) that may contain security information (e.g., key ID information, PN information, and/or MIC information), and a Trigger Dependent User Info subfield 2484 that may contain trigger dependent user information.

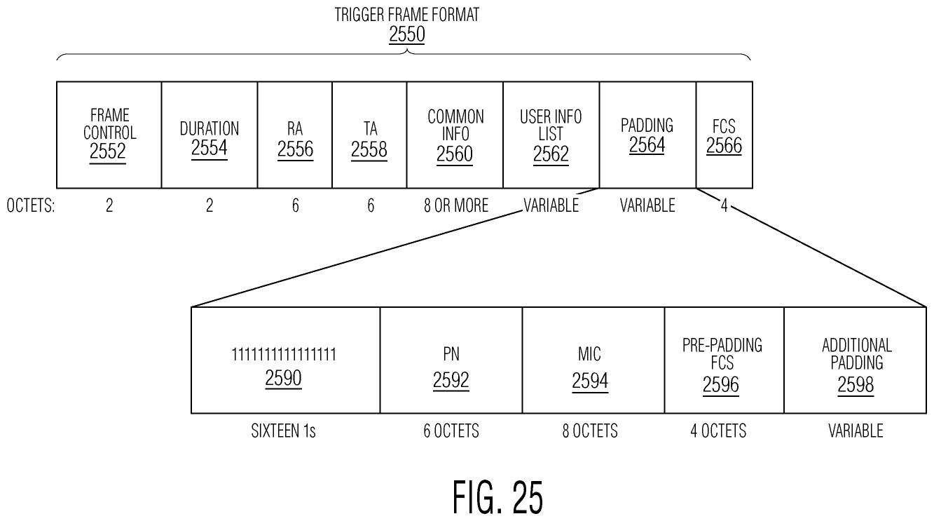

In some embodiments, in a third option, the Key ID is carried in the current reserved bits (as defined in an IEEE 802.11be protocol) of the Common Info field and/or the current reserve bits (as defined in an IEEE 802.11be protocol) of Special User Info field. In some embodiments, the indication whether the frame is protected is carried in the current reserved bits (as defined in an IEEE 802.11be protocol) of the Common Info field and/or the current reserve bits (as defined in an IEEE 802.11be protocol) of Special User Info field. In some embodiments, another variant is that the Key ID is carried right before PN and after 16-bit all Is. In some embodiments, in Padding, after 16-bit all Is, the PN, MIC and Pre-Padding FCS are carried, and the additional Padding, if exists, follows Pre-Padding FCS. In some embodiments, PN follows 12-bit all Is. FIG. 25 illustrates a trigger frame format 2550 in accordance with an embodiment of the invention. The trigger frame format 2550 illustrated in FIG. 25 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 25, the trigger frame format 2550 includes a frame control field 2552 (e.g., two-octet) that may contain frame control information, a frame duration field 2554 (e.g., two-octet) that may contain frame duration information, a RA (receiver address) field 2556 (e.g., six-octet) that may contain RA address information, a TA (transmitter address) field 2558 (e.g., six-octet) that may contain TA address information, a Common Info field 2560 (e.g., eight-octet or more) that may contain common information, a User Info List field 2562 (e.g., variable length) that may contain user information, a padding field 2564 (e.g., variable length) that may contain padding information, and a FCS field 2566 (e.g., four-octet) that may contain FCS information. The padding field 2564 may include a subfield 2590 that may contain sixteen 1s, a PN subfield 2592 (e.g., six-octet) that may contain packet number (PN) information, a MIC subfield 2594 (e.g., eight-octet or 16-octet) that may contain message integrity check (MIC) information, a Pre-Padding FCS subfield 2596 (e.g., eight-octet) that may contain pre-padding FCS information, and an additional Padding subfield 2598 (e.g., variable length) that may contain additional padding information.

Some implementations of Protected Multi-STA BA without Pre-Padding FCS, for example, by the wireless communications system 100 depicted in FIG. 1, the multi-link (ML) communications system 200 depicted in FIG. 2, and/or the wireless device 300 depicted in FIG. 3 are described. In some embodiments, the indication about whether the frame is protected is carried in one of the current reserved bits (defined in an IEEE 802.11be protocol) of the BA Control field, for example, by repurposing the current reserved bit. In some embodiments, the Key ID is carried in one of the current reserved bits (defined in an IEEE 802.11be protocol) of the BA Control field, for example, by repurposing the current reserved bit. In some embodiments, the PN and MIC are contained in one Security Per AID TID Info field. In some embodiments, a variant is that the Key ID, PN and MIC are in one Security Per AID TID Info field. In some embodiments, the Security Per AID TID Info field has 16-octet Security Info subfield that is indicated by the Fragment Number subfield in Block Ack Starting Sequence Control field. In some embodiments, the Padding Per AID TID Info field is 32-octet Padding Info subfield that is indicated by the Fragment Number subfield (with value 0) in Block Ack Starting Sequence Control field or a Per AID TID Info field to a specific STA. In such embodiments, the Ack Type subfield in Per AID TID Info field has a value of 0, the TID in Per AID TID Info field is reserved, and the AID11 subfield in Per AID TID Info field has a special value, e.g., 2016. In some embodiments, the Security Per AID TID Info field is located right after BA Information field carrying the acknowledgement information for one addressed STA/AP or multiple addressed STAs.

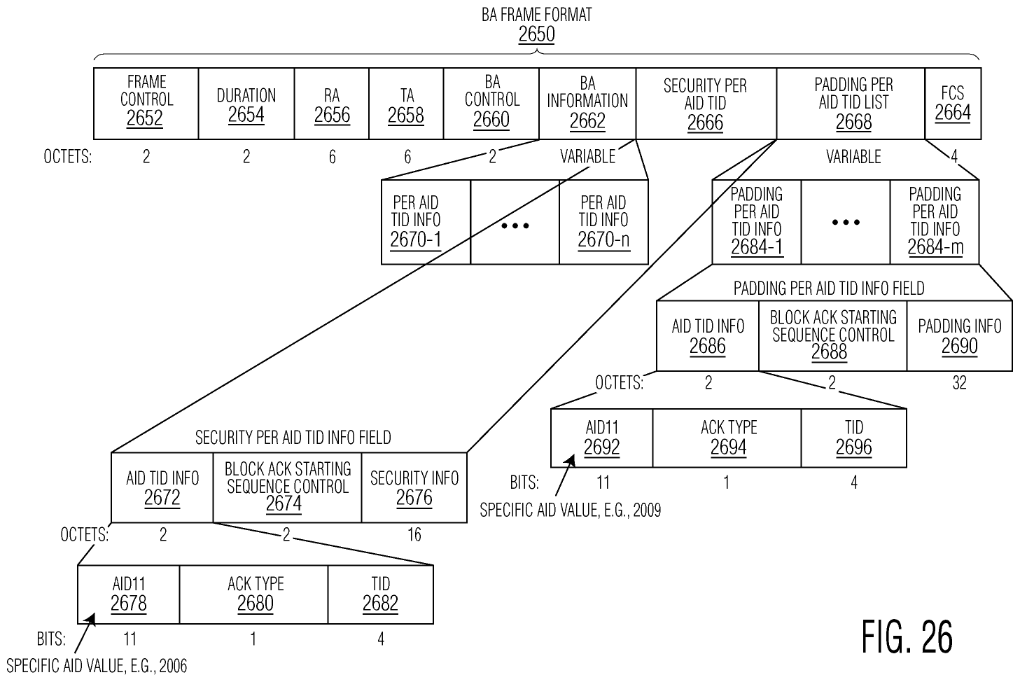

FIG. 26 illustrates a BA frame format 2650 in accordance with an embodiment of the invention. The BA frame format 2650 illustrated in FIG. 26 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 26, the BA frame format 2650 includes a frame control field 2652 (e.g., two-octet) that may contain frame control information, a frame duration field 2654 (e.g., two-octet) that may contain frame duration information, a RA (receiver address) field 2656 (e.g., six-octet) that may contain RA address information, a TA (transmitter address) field 2658 (e.g., six-octet) that may contain TA address information, a BA control field 2660 (e.g., two-octet) that may contain BA control information with one reserved bit (as defined in an IEEE 802.11be protocol) being repurposed/used to indicate whether the frame is protected control frame and with another one reserved bit (as defined in in an IEEE 802.11be protocol) being repurposed/used to indicate the Key ID), a BA information field 2662 (e.g., variable length) that may contain BA information, a FCS field 2664 (e.g., four-octet) that may contain FCS information, a Security Per AID TID field 2666 (e.g., four-octet) that may contain security Per AID TID information, and a Padding Per AID TID List field 2668 (e.g., four-octet) that may contain padding Per AID TID list information. The BA information field 2662 may include one or more Per AID TID Info fields 2670-1, . . . , 2670-n, where n is a positive integer, which may contain Per AID TID information. The Security Per AID TID field 2666 may contain an AID TID Info field 2672 (e.g., two-octet) that may contain AID TID information, a Block Ack Starting Sequence Control field 2674 (e.g., two-octet) that may contain block Ack starting sequence control information with its Fragment Number subfield to indicate the length of SECURITY INFO subfield 2676, and a Security Info field 2676 (e.g., sixteen-octet) that may contain security information. The AID TID Info field 2672 may contain an AID11 subfield 2678 (e.g., eleven-bits) that may contain AID information (for example, a specific AID value (e.g., 2009)), an Ack Type subfield 2680 (e.g., one-bit) that may contain Ack type information with value 0 to indicate that the SECURITY INFO 2676 exists, and a TID subfield 2682 (e.g., four-bit) that may contain TID information. The Padding Per AID TID List field 2668 may include one or more Padding Per AID TID fields 2684-1, . . . , 2684-m, where m is a positive integer, which may contain padding Per AID TID information. A least one of the Padding Per AID TID fields 2684-1, . . . , 2684-m may contain an AID TID Info field 2686 (e.g., two-octet) that may contain AID TID information, a Block Ack Starting Sequence Control field 2688 (e.g., two-octet) that may contain block Ack starting sequence control information with its Fragment Number subfield to indicate the length of PADDING INFO subfield 2690 if Ack Type subfield 2694 is equal to 1, and a Padding Info field 2690 (e.g., sixteen-octet) that may contain padding information if the padding is required by the recipient. The AID TID Info field 2686 may contain an AID11 subfield 2692 (e.g., eleven-bits) that may contain AID information (for example, a specific AID value (e.g., 2009)), an Ack Type subfield 2694 (e.g., one-bit) that may contain Ack type information with value 1 or 0, and a TID subfield 2696 (e.g., four-bit) that may contain TID information.

In some embodiments, a method of improving security for frame exchanges between a first device and at least one second device associated with the first device includes protecting, by the first device and the second device, some of control frames that are one of a trigger frame, a BAR frame, and a BA frame between the first device and the second device. In some embodiments, the method further includes in various protected BAR frames, a Key ID is carried in current reserved bits of a BAR Control field. In some embodiments, the method further includes in various protected BAR frames, for example, compressed BAR and multi-TID BAR, PN and MIC are carried right after a BAR Information field to carry the block ack request information (starting sequence number(s) and related TIDs if the frame is multi-TID BAR). In some embodiments, the method further includes in various Trigger frames, the Key ID is carried in one of the current reserved bits of a Common Info field or a Special User Info field, for example, by repurposing the current reserved bit. In some embodiments, the method further includes in various Trigger frames, the Key ID is carried in two of the current reserved bits of a Common Info field or a Special User Info field by repurposing the current two reserved bits. In some embodiments, the Security User Info field has the same length as the User Info field being addressed to a specific STA in a protected Trigger frame other than a MU-BAR frame. In some embodiments, if/when a Security User Info field includes Trigger Dependent User Info subfield, PN and MIC are not carried in a Trigger Dependent User Info field of the Security User Info field. In some embodiments, the Security User Info field in a protect MU-BAR has a 4-octet Trigger Dependent User Info subfield with a BAR Type subfield is set to indicate a Compressed BAR frame. In some embodiments, PN and MIC are not carried in a Trigger Dependent User Info field of the Security User Info field.

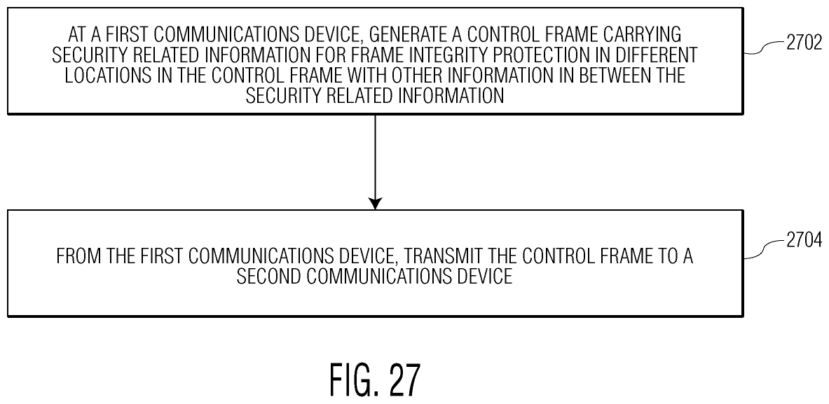

FIG. 27 is a process flow diagram of a method for wireless communications in accordance with an embodiment of the invention. At block 2702, at a first communications device, a control frame carrying security related information for frame integrity protection in different locations in the control frame with other information in between the security related information is generated. At block 2704, from the first communications device, the control frame is wirelessly transmitted to a second communications device. In some embodiments. In some embodiments, the security related information includes frame protection indication information regarding whether or not the control frame is a protected control frame, key identification (ID) information, packet number (PN) information, and message integrity check (MIC) information. In some embodiments, the frame protection indication information and the key ID information are separated from the PN information and the MIC information. In some embodiments, the PN information and the MIC information are located right after block acknowledgement request (BAR) Information in a protected BAR frame, right after block acknowledgement (BA) Information in a protected BA frame, or right after User Info List in a protected trigger frame. In some embodiments, the frame protection indication information, the key ID information, and the PN information are separated from the MIC information by other fields. In some embodiments, if additional processing time is required, the control frame further includes a padding field that is located after the MIC information if the control frame is a protected BAR frame or a protected BA frame. In some embodiments, the control frame further includes a pre-padding frame check sequence (FCS) field that is located after the MIC information. In some embodiments, the first communications device or the second communications device includes a wireless access point (AP), and the second communications device or the first communications device includes a wireless non-AP station (STA). In some embodiments, the control frame further includes a padding field that is located after the PN information. In some embodiments, the communications device includes a wireless access point (AP), and the second communications device includes a wireless non-AP station (STA). In some embodiments, the control frame includes a protected control frame, and frame protection indication information is carried in a reserved bit of the protected control frame. In some embodiments, the control frame includes a protected control frame, and frame protection indication information is repurposed by using a current reserved bit of the protected control frame. In some embodiments, the control frame includes a protected trigger frame, a protected block acknowledgement (BA) frame, or a protected block acknowledgement request (BAR) frame. In some embodiments, the control frame includes the protected trigger frame, and frame protection indication information or key identification (ID) information is carried in at least one reserved bit of a special user information field or a common information field of the protected trigger frame. In some embodiments, the control frame includes the protected trigger frame, and frame protection indication information or key ID information is repurposed by using at least one current reserved bit of a special user information field or a common information field of the protected trigger frame. In some embodiments, the PN information and the MIC information are carried in a Security User Info field with an AID12 field carrying a special value where the Security User Info field has the same length as a Special User Info field, a Trigger Dependent User Info field in each Security User Info field is reserved, only the User Info subfield in a last Security User Info field has reserved bits if not all User Info subfields are used. In some embodiments, a Pre-padding FCS is carried in a Pre-padding FCS Info field with an AID12 field carrying a special value where the Pre-padding FCS Info field has the same length as the Special User Info field, a Trigger Dependent User Info field in each Pre-padding FCS Info field is reserved, only the User Info subfield in last Pre-padding FCS Info field has reserved bits if not all FCS Info subfields are used. In some embodiments, the PN information and the MIC information are carried after 16-bit all Is in a Padding field. In some embodiments, a pre-padding FCS is carried after the PN information and the MIC information. In some embodiments, the control frame includes the protected BA frame, and frame protection indication information or key identification (ID) information is carried in at least one reserved bit of a BA control field of the protected BA frame. In some embodiments, the control frame includes the protected BAR frame, and frame protection indication information or key identification (ID) information is carried in at least one reserved bit of a BAR control field of the protected BAR frame. In some embodiments, the control frame includes the protected BA frame, and frame protection indication information or key identification (ID) information is repurposed by using at least one current reserved bit of a BA control field of the protected BA frame, the protected BA frame includes a protected multi-station (STA) BA frame where the PN information and the MIC information are carried in a Security Per AID TID Info field with a special value in an AID11 subfield, a value of 0 in an acknowledgement (Ack) Type subfield, and a value in a Fragment Number subfield to indicate a length of a Security Info field. In some embodiments, one or more Padding Per AID TID Info fields are carried after the Security Per AID TID Info field where padding if required by a recipient is carried in the Padding Per AID TID Info fields with a special value in an AID11 subfield, a value of 0 or 1 in an Ack Type subfield, and a value in a Fragment Number subfield to indicate a length of a Padding Info field. In some embodiments, the first communications device includes a wireless multi-link device (MLD), the second communications device includes a second wireless MLD, and the control frame is transmitted to the second wireless MLD through a wireless link between the wireless MLD and the second wireless MLD. In some embodiments, the first communications device and/or the second communications device are compatible with an Institute of Electrical and Electronics Engineers (IEEE) 802.11 protocol. In some embodiments, the first communications device is a component of a multi-link device (MLD). The first communications device and/or the second communications device may be the same as or similar to an embodiment of the AP 106 depicted in FIG. 1, the APs 206-1, 206-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A communications device comprising:
a controller configured to generate a control frame carrying security related information for frame integrity protection in a plurality of different locations in the control frame with other information in between the security related information; and
a wireless transceiver configured to wirelessly transmit the control frame to a second communications device.

2. The communications device of claim 1, wherein the security related information comprises frame protection indication information regarding whether or not the control frame is a protected control frame, key identification (ID) information, packet number (PN) information, and message integrity check (MIC) information.

3. The communications device of claim 2, wherein the frame protection indication information and the key ID information are separated from the PN information and the MIC information.

4. The communications device of claim 2, wherein the PN information and the MIC information are located right after block acknowledgement request (BAR) Information in a protected BAR frame, right after block acknowledgement (BA) Information in a protected BA frame, or right after a User Info List in a protected trigger frame.

5. The communications device of claim 2, wherein the frame protection indication information, the key ID information, and the PN information are separated from the MIC information by other fields.

6. The communications device of claim 2, wherein if additional processing time is required, the control frame further comprises a padding field that is located after the MIC information if the control frame is a protected block acknowledgement request (BAR) frame or a protected block acknowledgement (BA) frame.

7. The communications device of claim 2, wherein the control frame further comprises a pre-padding frame check sequence (FCS) field that is located after the MIC information.

8. The communications device of claim 1, wherein the communications device or the second communications device comprises a wireless access point (AP), and wherein the second communications device or the communications device comprises a wireless non-AP station (STA).

9. The communications device of claim 1, wherein the control frame comprises a protected control frame, and wherein frame protection indication information is repurposed by using a current reserved bit of the protected control frame.

10. The communications device of claim 2, wherein the control frame comprises a protected trigger frame, a protected block acknowledgement (BA) frame, or a protected block acknowledgement request (BAR) frame.

11. The communications device of claim 10, wherein the control frame comprises the protected trigger frame, and wherein frame protection indication information or key identification (ID) information is repurposed by using at least one current reserved bit of a special user information field or a common information field of the protected trigger frame.

12. The communications device of claim 11, wherein the PN information and the MIC information are carried in a Security User Info field with an AID12 field carrying a special value where the Security User Info field has same length as a Special User Info field, a Trigger Dependent User Info field in each Security User Info field is reserved, only a User Info subfield in a last Security User Info field has reserved bits if not all User Info subfields are used.

13. The communications device of claim 11, wherein a Pre-padding frame check sequence (FCS) is carried in a Pre-padding FCS Info field with an AID12 field carrying a special value where the Pre-padding FCS Info field has same length as a Special User Info field, a Trigger Dependent User Info field in each Pre-padding FCS Info field is reserved, only a User Info subfield in last Pre-padding FCS Info field has reserved bits if not all FCS Info subfields are used.

14. The communications device of claim 11, wherein the PN information and the MIC information are carried after 16-bit all 1s in a Padding field.

15. The communications device of claim 11, wherein a pre-padding frame check sequence (FCS) is carried after the PN information and the MIC information.

16. The communications device of claim 10, wherein the control frame comprises the protected BA frame, wherein frame protection indication information or key identification (ID) information is repurposed by using at least one current reserved bit of a BA control field of the protected BA frame, and wherein the protected BA frame comprises a protected multi-station (STA) BA frame where the PN information and the MIC information are carried in a Security Per AID TID Info field with a special value in an AID11 subfield, a value of 0 in an acknowledgement (Ack) Type subfield, and a value in a Fragment Number subfield to indicate a length of a Security Info field.

17. The communications device of claim 16, wherein one or more Padding Per AID TID Info fields are carried after the Security Per AID TID Info field where padding if required by a recipient is carried in the Padding Per AID TID Info fields with a special value in an AID11 subfield, a value of 0 or 1 in an Ack Type subfield, and a value in a Fragment Number subfield to indicate a length of a Padding Info field.

18. The communications device of claim 10, wherein the control frame comprises the protected BAR frame, wherein frame protection indication information or key identification (ID) information is repurposed by using at least one reserved bit of a BAR control field of the protected BAR frame, and wherein the protected BAR frame comprises a protected compressed BAR frame or a protected compressed multi-TID BAR frame where the PN information and the MIC information are located after BAR information and padding required by a recipient is carried after the MIC information.

19. A wireless access point (AP) compatible with an Institute of Electrical and Electronics Engineers (IEEE) 802.11 protocol, the wireless AP comprising:
a controller configured to generate a control frame carrying security related information for frame integrity protection in a plurality of different locations in the control frame with other information in between the security related information; and
a wireless transceiver configured to wirelessly transmit the control frame to a second communications device.

20. A method for wireless communications, the method comprising:
at a first communications device, generating a control frame carrying security related information for frame integrity protection in a plurality of different locations in the control frame with other information in between the security related information; and
from the first communications device, wirelessly transmitting the control frame to a second communications device.
